(19) United States
(12) Patent Application Publication
(10) Pub. No.: US 2008/0217402 A1
(43) Pub. Date: Sep. 11, 2008

(54) Maturity Rating Enforcement Via Rf-Tags

(75) Inventor: Johannes Hendrikus Maria Lemmers, Reek (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,282

(22) PCT Filed: Sep. 27, 2006
(86) PCT No.: PCT/IB2006/053525

§ 371 Date: Mar. 27, 2008

Related U.S. Application Data
(60) Provisional application No. 60/722,902, filed on Sep. 30, 2005.

(51) Int. Cl. G06K 5/00

(52) U.S. Cl. 235/382

(57) ABSTRACT

Maturity levels of those present to watch a television program are automatically and transparently determined and matched to a derived maturity rating of the candidate program (S244). If none of the detected levels achieves the rating, the program is blocked (S234). Presence is preferably determined by communication exchange with wearable RFID tags (144).

The present invention relates to enforcing maturity ratings of programs that are to be shown. More particularly, the present invention is directed to automatic enforcement based on the particular individuals present at the showing.

Rating of television programs has existed for decades. These ratings often indicate when a program is not suitable for children or that discretion should be exercised in allowing the program to be viewed. Content can be screened according to user settings to a set-top box, for example. For an adult to view content that is otherwise screened might require entry of an override code. This extra step is inconvenient, and can be overlooked if the adult is mainly busy with something else, e.g., house chores. As a result, a program that the person may have wanted to see may be precluded from presentation on the nearby television screen. Also, the override may be done often in the presence of a younger person, because the adult has decided that there is no need to block the particular program currently available for showing. The child may therefore learn how to perform the override, and consequently be able to view future programs without parental oversight.

To overcome the above-noted shortcomings, it is sensed, according to the present invention, for an individual of preselected individuals, whether or not the individual is present in a predetermined area. Dependent upon an outcome of the sensing and upon a maturity rating of a program that is a candidate for current presentation in the area, current presentation of the program in the area is blocked.

Details of the invention are set forth below with the aid of the following drawings, wherein:

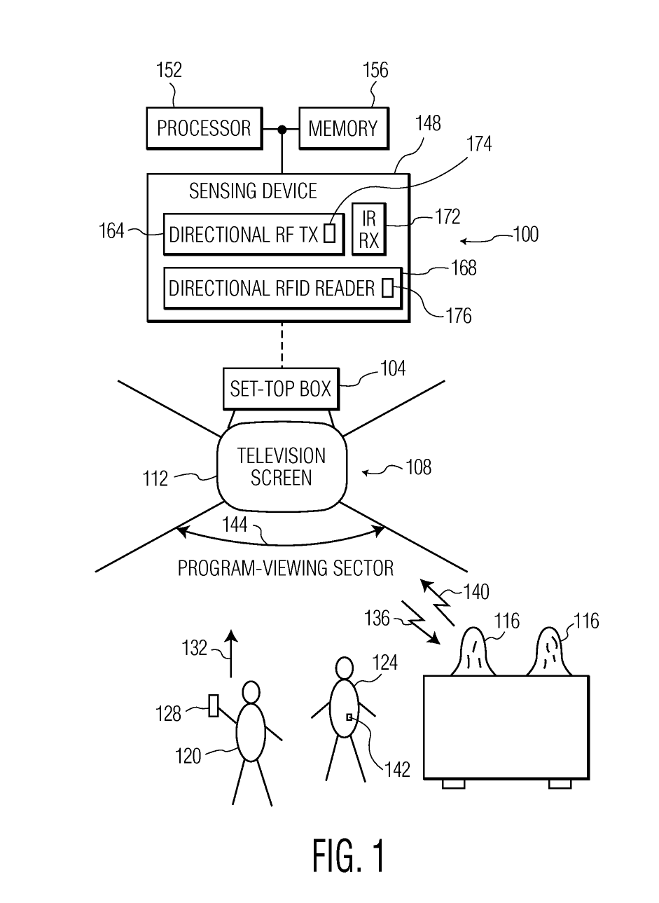

FIG. 1 is an illustration providing an overview of a maturity rating enforcement system in the context of an ambient environment, according to the present invention; and

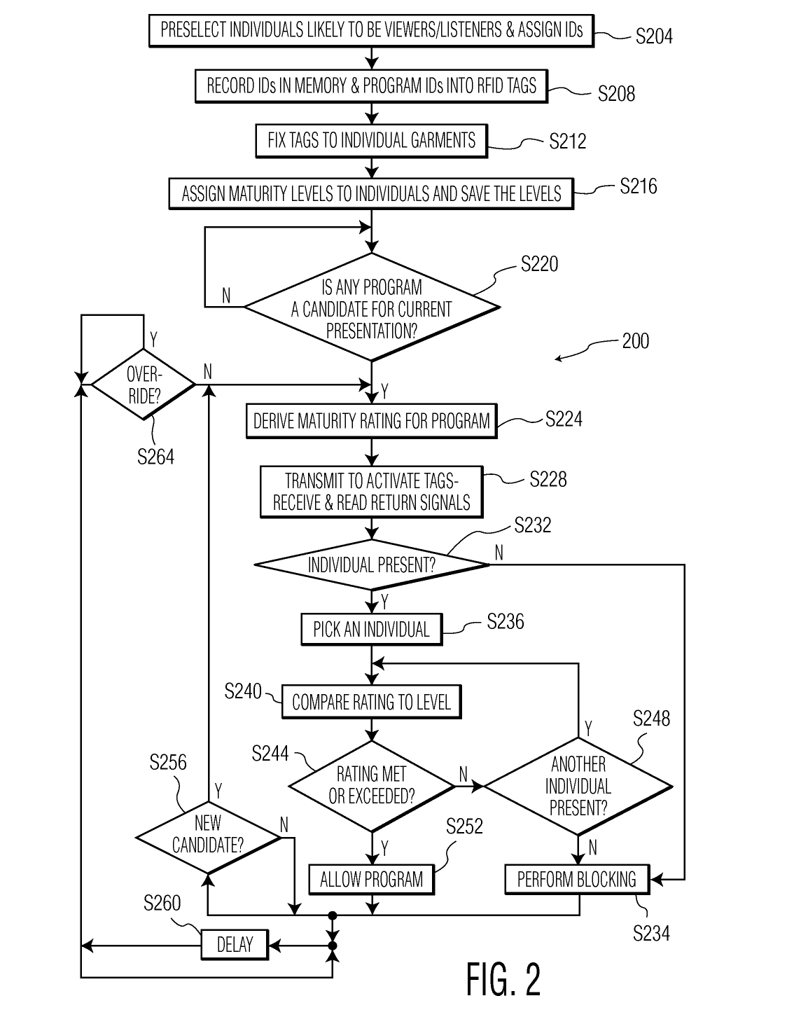

FIG. 2 is a flow chart of a process for enforcing maturity ratings in the system of FIG. 1.

Referring to FIG. 1, a maturity rating enforcement system 100 is implemented, by way of illustrative and non-limitative example, in a set-top, cable or dish box 104. The underlying television 108 has a display screen 112 viewable by the adults 116, the child 120 and the minor 124 present. The minor 124 is shown holding a remote control device 128 for the set-top box 104. The remote control 128 typically sends out an infrared (IR) signal 132 for activating/deactivating the set-top box 104, changing the channel, soliciting information, programming the set-top box, etc. Also shown are radio frequency (RF) signals 136, 140 to and from the set-top box 104. These are for activating wearable RF tags or transponders 142 so as to monitor who is present in a program-viewing sector 144. The transponders 142 can be sewn into undergarments, such as underwear, or be otherwise fixed to individual garments of the household members, or be worn as bracelets or jewelry. The RFID tags 142 can be made very small, to the thickness of a product label for example, and encased to make them moisture-proof.

The maturity rating enforcement system 100 includes a sensing device 148, a processor 152 and storage memory 156, connected mutually on a data and control bus 160. The processor 152 acts as a controller for the sensing device 148 and executes the logic discussed below in connection with FIG. 2. The processor 152 includes a timer or clock (not shown) that keeps the current time. Thus, an electronic programming guide (EPG) or interactive program guide (IPG), which typically includes rating data as well as time schedules, can be consulted for the rating of the program being subject to maturity-rating enforcement. The storage memory 156 preferably includes permanent or non-volatile storage, as well as temporary or working storage. The latter typically would include random access memory (RAM). Permanent storage can take the form of read-only memory (ROM) of flash memory. Any variation of the above memory devices can be utilized.

The sensing device 148 preferably features a directional RF beacon or transmitter 164 and a directional RF identifier (RFID) reader 168. It also has an infrared receiver or pickup device 172 to receive IR signals 132 from the remote control 128. The transmitter 164 has at least one antenna 174 that is preferably directional so that coverage is afforded over the sector 144 which may be 120 degrees or more. The reader 168 is likewise configured with at least one antenna 176, preferably directional and which may be integral with the antenna 174 so that transmission and reception occur on the same antenna. Alternatively, an omni-directional RF transceiver can be utilized, although an adult standing alongside the television but not in viewing position will, by his or her presence, be assumed to have authorized viewing. Transmission is preferably by means of Bluetooth or IEEE 802.11 (WiFi) protocol. The sensing device 148 is not, however, limited to RF technology, and may be implemented by using other types of electromagnetic radiation. The sensing device 148 may, for example, utilize a camera to perform image recognition, such as face recognition, by methods well-known in the art. It is contemplated that magnetic means may also be developed to sense presence of individuals. Although the maturity enforcement system 100 is shown contained within a set-top box, it is understood that the system can be incorporated into the television 108, a multimedia computer, audio system or other entertainment- or education-oriented consumer electronic presentation device. The device may be fixed, mobile or hand-portable.

Each transponder 142 carries, within its memory, an identifier of an individual whose garment is to carry the transponder. The identifiers embedded in the transponder memory, which may be an electrically-erasable programmable read-only memory (EEPROM), can be factory pre-set or programmable by the user. The transponder 142 may be active, i.e., include a battery, or be passive, receiving activation energy by means of the RF signal 136. In either case, the transponder 142, upon receiving an activation signal 136, responds by transmitting its unique identifier back to the sensing device 148. An example of an identifier is one or more alphanumeric characters. Although, an identifier may be a reference image for comparison with a captured image in the case of image-recognition based identification.

FIG. 2 depicts an exemplary process 200 for enforcing maturity ratings in the system of FIG. 1. In step S204, selection is made of the individuals who are to participate in the maturity ratings enforcement process 200. These are typically the household members, the individuals likely to view and/or listen to a candidate program for current presentation in the designated area or program-viewing sector 144. To each selected individual, a unique identifier is assigned. These identifiers can be supplied with the RFID tag 142, or, alternatively, the user can select identifiers for programming into the tags. The identifiers are entered into the storage memory 156 by means of the user interface involving the screen 112 and the remote control 132 (step S208). The RFID tags 142 containing the assigned identifiers must be placed in physical association with each of the selected individuals. Therefore, the tags 142 are sewn into or otherwise fixed to the undergarments of the household members 116, 120, 124 so that each undergarment is attached to a transponder having that member's unique identifier (step S212). By means of the user interface, for instance, respective maturity levels are assigned to each of the participating members 116, 120, 124. For example, parents enjoy the highest level or rights, a child 13 years old has a rating of 12+, and a child of 4 has the lowest level (step S216).

In operation, the processor 152 queries if any program is a candidate for current presentation in the program-viewing sector 144. If the user changes the channel, then the program on the destination channel is a candidate for current presentation. As a second example, as one program ends and the next program begins, that next program becomes a candidate for current presentation (step S220). If no candidate program exists, the system 100 waits.

When a candidate program exists, a maturity rating for the program is derived. For broadcasted television and cable programs, the maturity rating may be read from the EPG or IPG based on the current time as determined by the timer in the sensing device 148. Alternatively, for candidates arising from transition to the next program, the rating information is also available in the incoming video signal. For this alternative, the video signal may, or may be augmented to, provide the rating information continuously, so that the information is available when the channel is changed (step S224).

Also in response to detecting candidacy for current presentation, performed serially or in parallel with the rating derivation step, an RF activation signal 136 is transmitted throughout the program-viewing sector 144, and identifiers are read from the signals returned by the RFID tags 142 (step S228).

Alternatively, the interrogation and return signal exchange need not by restricted to this point in time. Instead, the system 100 may be designed to continuously or periodically monitor presence in the program-viewing sector 144, or in the room if omnidirectional coverage is implemented. One example is the use of motion sensors, so that detected motion triggers an exchange. Another example would be stepping on a pressure-sensitive floor mat to provide the trigger, the mats being provided under the carpet at entry and exit points.

Next, it is determined whether anyone is detected, as a result of the current exchange, as being present in the sector 144 (step S232). If nobody is detected to be present, blocking is performed (step S234), preferably at all levels. Thus, PG-13 movies as well as movies rated R, are blocked. Whether candidacy of the program has arisen due to start of the program or by channel change, any display of content of the program is blocked by an intervening screen that may say “Not Authorized” or otherwise explain the program block. The block preferably includes muting audio and suppressing transcription.

If a person is detected to be present, the person's maturity level is retrieved and compared to the program maturity rating that has just been determined (steps S236, S240). If the rating is not met or exceeded by the maturity level (step S244), the comparison is made for a next one of the persons, if any, detected as present (step S248). If no one else has been detected as present, the candidate program is blocked (step S234). On the other hand, if the rating is met or exceeded, blocking is precluded (step S252).

Once the decision is made to block or not block, the system 100 waits for candidacy to arise once again by start of a new program or by channel change (S256), at which point the program's maturity rating is derived (step S224).

However, while the system 100 waits for new candidacy, it could occur that an adult who was present when the current program was authorized might leave and that a child younger than those present might subsequently arrive during the program. Moreover, even if the younger child does not arrive, the adult might have been called away unexpectedly, leaving viewers present who would not have had the priority needed to authorize the current program. In this latter case, it is unclear whether the adult was conditionally allowing presence subject to his or her overview.

One solution is to incorporate into the process 200 a delay so that the cycle of determining who is present is repeated periodically (step S260). Accordingly, a program in progress is blocked, subject to at least one authorizing person remaining within the program-viewing sector 144 as determined periodically, e.g., every 15 seconds. If the leaving individual does not want presentation to be interrupted by their absence, which may be temporary, an override can be entered by means of the remote control 128 (step S264). Entry of the override freezes, during the pendency of the override, periodic monitoring of those present. The override can likewise be removed by means of the remote control 128.

Advantageously, the system 100 operates transparently and automatically, without the need for user input once the system has been set up, and the problem of passwords being seen during entry is eliminated.

While there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it should be recognized that structures and/or elements and/or method steps shown and/or described in connection with any disclosed form or embodiment of the invention may be incorporated in any other disclosed or described or suggested form or embodiment as a general matter of design choice.

1. A computer implemented method for automatically enforcing maturity ratings, comprising:
sensing, for an individual of preselected individuals, whether or not said individual is present in a predetermined area (S228); and,
dependent upon an outcome of said sensing and upon a maturity rating of a program that is a candidate for current presentation in said area, blocking said program from said current presentation in said area (S234).

2. The method of claim 1, further comprising detecting the candidacy, said sensing and said blocking being triggered by detection of said candidacy (S220, S256).

3. The method of claim 1, wherein said area is a program-viewing sector (144).

4. The method of claim 3, wherein said sensing comprises using a directional antenna in covering said sector (174, 176).

5. The method of claim 1, further comprising recording respective identifiers of the preselected individuals (S208), wherein said sensing is performed by a sensing device and comprises receiving electromagnetic radiation and comparing content of received radiation with the recorded identifiers (S236, S248).

6. The method of claim 1, further comprising:
assigning respectively maturity levels to the preselected individuals (S216); and
determining whether said maturity rating is at least one of met or exceeded by at least one of the assigned maturity levels of the preselected individuals currently sensed in said sensing, said blocking being dependent upon an outcome of said determining (S244).

7. The method of claim 6, further comprising performing said blocking unless said determining determines that said maturity rating is at least one of met or exceeded (S234).

8. The method of claim 1, further comprising fixing, to garments of the preselected individuals, respective radio frequency transponders (S212), wherein said sensing communicates with a transponder of said transponders.

9. The method of claim 1, further comprising recording respective identifiers of the preselected individuals (S208), wherein said sensing comprises receiving electromagnetic radiation and comparing content of received radiation with the recorded identifiers.

10. The method of claim 1, further comprising saving, for the preselected individuals, respective maturity levels, said blocking being dependent upon a result of comparison with one or more of the saved levels (S244).

11. The method of claim 10, further comprising assigning, according to age of the respective preselected individual, said maturity levels to be saved (S240).

12. A consumer electronic device for automatically enforcing maturity ratings, comprising:
a sensing device configured for sensing, for an individual of preselected individuals, whether or not said individual is present in a predetermined area (148); and
a processor configured for, dependent upon an outcome of said sensing and upon a maturity rating of a program that is a candidate for current presentation in said area, blocking said program from said current presentation in said area (152).

13. The device of claim 12, said processor being configured for detecting the candidacy (S220, S256), said sensing and said blocking being triggered by detection of said candidacy.

14. The device of claim 12, wherein said area is a program-viewing sector (144).

15. The device of claim 14, wherein said sensing device comprises a directional antenna for use in covering said sector (174, 176).

16. The device of claim 12, configured for recording respective identifiers of the preselected individuals, wherein said sensing comprises receiving electromagnetic radiation and comparing content of received radiation with the recorded identifiers (S228).

17. The device of claim 12, said processor being configured for:
assigning, respectively, maturity levels to the preselected individuals (S216); and
determining whether said maturity rating is at least one of met or exceeded by at least one of the assigned maturity levels of the preselected individuals currently sensed in said sensing (S244), said blocking being dependent upon an outcome of said determining.

18. The device of claim 17, said processor being configured for performing said blocking unless said determining determines that said maturity rating is at least one of met or exceeded (S244, S234).

19. The device of claim 12, said processor being configured for saving, for the preselected individuals, respective maturity levels (S208), said blocking being dependent upon a result of comparison with one or more of the saved levels.

20. The device of claim 19, said processor being configured for assigning, according to age of the respective preselected individual, said maturity levels to be saved (S216).

21. The device of claim 12, wherein said sensing comprises sending a radio frequency signal across said area, and receiving back a return signal (136, 140).

22. The device of claim 12, configured for causing said sensing device to periodically monitor presence of said preselected individuals, said processor being configured for allowing the user to override said periodic monitoring (S256, S260, S264).

23. A computer program product, for automatically enforcing maturity ratings, comprising a program embedded in a computer readable medium and having instructions executable by a processor to perform acts, said acts comprising:
sensing, for an individual of preselected individuals, whether or not said individual is present in a predetermined area (S228); and,
dependent upon an outcome of said sensing and upon a maturity rating of a program that is a candidate for current presentation in said area, blocking said program from said current presentation in said area (S234).
